(19) United States
(12) Patent Application Publication
(10) Pub. No.: US 2014/0152540 A1
(43) Pub. Date: Jun. 5, 2014

(54) GESTURE-BASED COMPUTER CONTROL

(71) Applicants: Franck Franck, Dublin (IE); Eric B. Jul, Roskilde (DK)

(72) Inventors: Franck Franck, Dublin (IE); Eric B. Jul, Roskilde (DK)

(21) Appl. No.: 13/693,651

(22) Filed: Dec. 4, 2012

(51) Int. Cl. G06F 3/01

(52) U.S. Cl. CPC G06F 3/011
USPC 345/156

(57) ABSTRACT

Instead of controlling a computer by means of a hardware controller (e.g., keyboard, mouse, remote control, etc.), the present application provides systems and methods for a user to control a computer by performing certain body movements or postures (herein referred to as “gestures”) that are recognized by the computer and translated into computer commands.

### FIELD OF INVENTION

The invention is related to computer control.

### BACKGROUND

Computers are often used to assist in the presentation of information to large groups of people. Multi-media enabled computers can complement oral presentations with both auditory and visual information. However, interactions with a computer during a presentation can be disruptive to the flow of the presentation.

### SUMMARY

In one embodiment, a non-transitory, tangible computer-readable medium stores instructions adapted to be executed by a computer processor to perform a method for gesture-based computer control, comprising receiving, by the computer processor, a video signal; identifying, by the computer processor, pre-defined gestures in the video signal; and generating, by the computer processor, computer commands corresponding to the pre-defined gestures in the video signal.

In some embodiments of the above tangible computer-readable medium, the method further comprises transmitting, by the computer processor, the computer commands to an application executed by the processor.

In some embodiments of any of the above tangible computer-readable media, the method further comprises transmitting, by the computer processor, the computer commands to a remote computer.

In some embodiments of any of the above tangible computer-readable media, the application is a presentation program and the computer commands are for controlling the presentation program.

In some embodiments of any of the above tangible computer-readable media, the computer commands are for controlling a presentation program in the remote computer.

In some embodiments of any of the above tangible computer-readable media, the video signal is received from only a single camera.

In one embodiment, a computer-implemented method for gesture-based computer control, comprises receiving, by a computer processor, a video signal; identifying, by the computer processor, pre-defined gestures in the video signal; and generating, by the computer processor, computer commands corresponding to the pre-defined gestures in the video signal.

Some embodiments of the above computer implemented method further comprise transmitting, by the computer processor, the computer commands to an application executed by the processor.

Some embodiments of any of the above computer-implemented methods transmitting, by the computer processor, the computer commands to a remote computer.

In some embodiments of any of the above computer-implemented methods, the application is a presentation program and the computer commands are for controlling the presentation program.

In some embodiments of any of the above computer-implemented methods, the computer commands are for controlling a presentation program in the remote computer.

In some embodiments of any of the above computer-implemented methods, the video signal is received from only a single camera.

In one embodiment, a computer system for generating gesture-based computer commands, comprises a processor configured to receive a video signal; identify pre-defined gestures in the video signal; and generate computer commands corresponding to the pre-defined gestures in the video signal.

Some embodiments of the above system further comprise a storage device in communication with the processor, the storage device storing a gesture-recognition application comprising instructions to be executed by the processor for identifying pre-defined gestures in the video signal.

In some embodiments of any of the above systems, the gesture-recognition application further comprises instructions to be executed by the processor for generating computer commands corresponding to the pre-defined gestures in the video signal.

Some embodiments of any of the above systems further comprise a single camera for generating the video signal.

Some embodiments of any of the above systems further comprise a storage device in communication with the processor, the storage device storing an application.

In some embodiments of any of the above systems, the processor is further configured to transmit the computer commands to the application.

In some embodiments of any of the above systems, the application is a presentation program.

In some embodiments of any of the above systems, the computer commands are for controlling a presentation executed by the presentation program.

### BRIEF DESCRIPTION OF THE DRAWINGS

The foregoing summary, as well as the following detailed description of the embodiments, is better understood when read in conjunction with the appended drawings. For the purpose of illustrating the invention, various embodiments are shown in the drawings, it being understood, however, that the invention is not limited to the specific embodiments disclosed. In the drawings:

FIG. 1 shows an illustration of an exemplary implementation for generating gesture-based computer commands;

FIG. 2 shows block diagram of an exemplary implementation for generating gesture-based computer commands;

FIG. 3 shows block diagram of another exemplary implementation for generating gesture-based computer commands; and

FIG. 4 shows block diagram of another exemplary implementation for generating gesture-based computer commands.

### DETAILED DESCRIPTION

Before the various embodiments are described in further detail, it is to be understood that the invention is not limited to the particular embodiments described. It will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. It is also to be understood that the terminology used is for the purpose of describing particular embodiments only, and is not intended to limit the scope of the claims of the present application.

In the drawings, like reference numerals refer to like features of the systems and methods of the present application. Accordingly, although certain descriptions may refer only to certain Figures and reference numerals, it should be understood that such descriptions might be equally applicable to like reference numerals in other Figures.

The present application provides gesture-based control of a computer application. Instead of controlling a computer by means of a hardware controller (e.g., keyboard, mouse, remote control, etc.), the present application provides systems and methods for a user to control a computer by performing certain body movements or postures (herein referred to as “gestures”) that are recognized by the computer and translated into computer commands. Additionally, as used herein, the term “gestures” may include manipulation of a laser pointer or other light source, which may be easily detected by the computer and translated into computer commands.

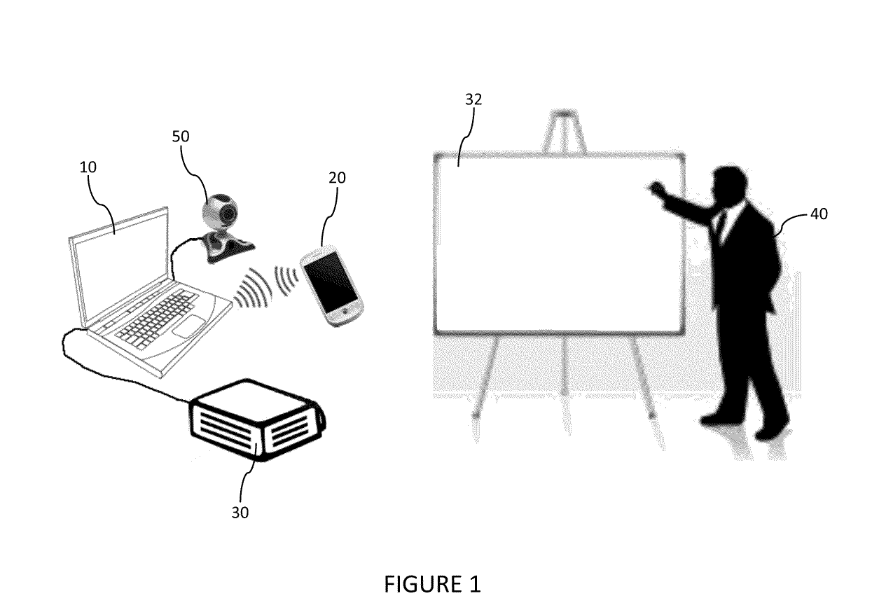

As shown in FIG. 1, the systems and methods of the present application may be implemented in various embodiments. For example, as shown in FIG. 1, the systems and methods of the present application may be implemented in a computer system 10 (e.g., laptop), a mobile computing device 20 (e.g., smart-phone), a multi-media apparatus 30 (e.g., video projector) or other electronic equipment having suitable computer processing capabilities. As shown in FIG. 1, the various implementations of the systems and methods of the present application may be used by a user 40 to control computer applications by performing pre-defined gestures that are captured by a camera 50 and translated into computer commands.

More particularly, in one embodiment, the user 40 may have a presentation prepared on the computer system 10 (e.g., laptop), which is connected to the projector 30. The projector 30 may be set up to project an image of the presentation onto a projection screen 32. Further, as shown in FIG. 1, the camera 50 may be connected to the computer system 10 to capture visual information about the user 40 as the user 40 gives the presentation. Alternatively, the camera 50 may be built-in to the computer system 10 (e.g., laptop's built-in webcam). The computer system 10 may receive a video signal from the camera 50 and identify pre-defined gestures performed by the user 40 and generate computer commands corresponding to the pre-defined gestures identified from the video signal. Accordingly, different pre-defined gestures may be associated with different commands for controlling the presentation (e.g., next slide, previous slide, etc.).

In another embodiment, rather than using the camera 50 that may be connected to or built into the computer system 10, a mobile computing device 20 with a built-in camera (e.g., smart-phone, tablet computer, etc.) may be used to capture visual information about the user 40 as the user 40 gives the presentation. The mobile computing device 20 may transmit the video signal to the computer system 10, which may identify pre-defined gestures performed by the user 40 from the video signal and generate computer commands corresponding to the pre-defined gestures identified from the video signal. Alternatively, the mobile computing device 20 may process the video signal and identify pre-defined gestures performed by the user 40, and further generate computer commands corresponding to the pre-defined gestures identified from the video signal and transmit the computer commands to the computer system 10. The transmission of the video signal or computer commands from the mobile computing device 20 to the computer system 10 may be done over any suitable wired (e.g., USB) or wireless (e.g., WiFi™, Bluetooth®, infrared, etc.) communication link.

In another embodiment, the user 40 may register his facial features with the computer system 10 so that the computer system 10 can be configured to respond to only the user's gestures during the user's presentation. Accordingly, for example, a meeting facility may be set up with a built-in computer system 10, projector 30, projection screen 32 and camera 50 so that a registered guest user 40 can make a presentation. The registered user 40 may load a presentation onto the computer system 10 (e.g., by means of a USB memory stick) so that it can be projected onto the projection screen 32 by the projector 30. The camera 50 may be connected to the computer system 10 to recognize the registered user 40 and capture visual information about the user 40 as the user 40 gives the presentation. The computer system 10 receives a video signal from the camera 50 and identifies pre-defined gestures performed by the registered user 40 and generates computer commands corresponding to the pre-defined gestures identified from the video signal.

Additionally, more than one user 40 may be registered with the computer system 10 so that the computer system 10 may be configured to respond to different users' gestures at different times. For example, after a first registered user is done with a presentation, the first user can handover control of the computer system 10 to a second registered user so that the second user can make a presentation. The handover of control from a first registered user to a second registered user may be accomplished by the first user performing a handover gesture, which may bring up the next presentation and configure the computer system to respond to only the second user's gestures during the second user's presentation. Accordingly, control of the computer system 10 can be handed over from one registered user to another.

In another embodiment, the camera 50 may be integrated into the projector 30 to capture visual information about the user 40 as the user 40 gives the presentation. The projector 30 may transmit the video signal to the computer system 10, which may identify pre-defined gestures performed by the user 40 from the video signal and generate computer commands corresponding to the pre-defined gestures identified from the video signal. Alternatively, the projector 30 may comprise a processor to process the video signal and identify pre-defined gestures performed by the user 40, and further generate computer commands corresponding to the pre-defined gestures identified from the video signal and transmit the computer commands to the computer system 10. The transmission of the video signal or computer commands from the projector 30 to the computer system 10 may be done over any suitable wired connection (e.g., HDMI®, DVI, USB, etc.) or wireless connection (e.g., WiFi™, Bluetooth®, infrared, etc.).

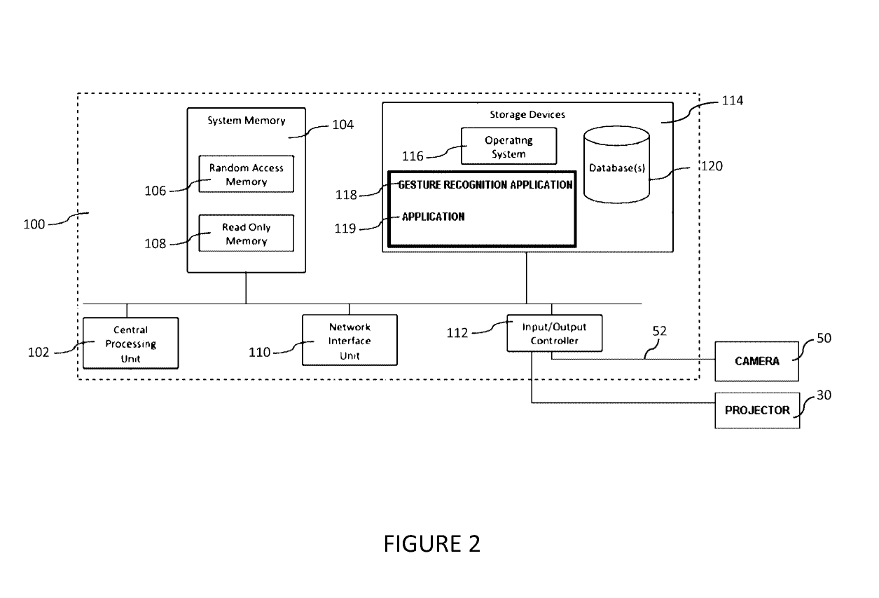

FIG. 2 shows an exemplary computing device 100 for implementing gesture-based control of a computer in accordance with the present application. The elements of computing device 100 may be implemented in one or more of a computer system 10, a mobile computing device 20, a multi-media apparatus 30 and a camera 50 as shown in FIG. 1 and as will be described in greater detail below.

The computing device 100 may comprise a central processing unit (CPU) 102, system memory 104, which may include a random access memory (RAM) 106 and a read-only memory (ROM) 108, a network interface unit 110, an input/output controller 112, and a data storage device 114. All of these latter elements are in communication with the CPU 102 to facilitate the operation of the computing device 100. The CPU 102 may be connected with the network interface unit 110 such that the CPU 102 can communicate with other devices.

The network interface unit 110 may include multiple communication channels for simultaneous communication with other devices. A variety of communications protocols may be part of the system, including but not limited to: Ethernet, SAP®, SAS®, ATP, BLUETOOTH®, GSM and TCP/IP. The CPU 102 may also be connected to the input/output controller 112 such that the CPU 102 can interface with computer peripheral devices (e.g., a video display, a keyboard, a computer mouse, etc.). Further, the CPU 102 may be connected with the data storage device 114, which may comprise an appropriate combination of magnetic, optical and semiconductor memory. The CPU 102 and the data storage device 114 each may be, for example, located entirely within a single computer or other computing device; or connected to each other via the network interface unit 110.

Suitable computer program code may be provided for executing numerous functions. For example, the computer program code may include program elements such as an operating system and “device drivers” that allow the processor to interface with computer peripheral devices (e.g., a video display, a keyboard, a computer mouse, etc.). The data storage device 114 may store, for example, (i) an operating system 116; (ii) one or more applications 118, 119 (e.g., computer program code and/or a computer program product) adapted to direct the CPU 102; and/ or (iii) database(s) 120 adapted to store information that may be utilized by one or more applications 118, 119.

The applications 118, 119 may be implemented in software for execution by the CPU 102. An application of executable code may, for instance, comprise one or more physical or logical blocks of computer instructions, which may, for instance, be organized as an object, procedure, process or function. Nevertheless, the executables of an identified application need not be physically located together, but may comprise separate instructions stored in different locations which, when joined logically together, comprise the application and achieve the stated purpose for the application. For example, an application of executable code may be a compilation of many instructions, and may even be distributed over several different code partitions or segments, among different programs, and across several devices. Also, the applications 118, 119 may be implemented in programmable hardware devices such as field programmable gate arrays, programmable array logic, programmable logic devices or the like. Thus, embodiments of the present invention are not limited to any specific combination of hardware and software.

As shown in FIG. 2, in order to provide gesture-based computer commands, a gesture-recognition application 118 may be implemented in the computing device 100. Also, as shown in FIG. 2, the camera 50 may be connected to the computing device 100 via input/output controller 112 to capture visual information about the user 40 and generate a video signal 52. The video signal 52 from the camera 50 may be transmitted to the CPU 102 via the via input/output controller 112. Although the camera 50 is shown as a separate peripheral device, the camera 50 may be integrated in the computing device 100 (e.g., laptop built-in webcam).

The gesture-recognition application 118 may comprise computer instructions for execution by the CPU 102. The gesture-recognition application 118 may include information regarding pre-defined gestures to be identified from the video signal 52 and computer commands corresponding to the pre-defined gestures. Further, the gesture-recognition application 118 may comprise instructions for storing and processing the video signal 52 received from the camera 50, identifying predefined gestures performed by the user 40 from the video signal 52, and generating computer commands corresponding to the pre-defined gestures identified from the video signal 52. The process of identifying predefined gestures performed by the user 40 from the video signal 52 may be accomplished by employing known gesture recognition frameworks. Additionally, the gesture-recognition application 118 may comprise instructions for processing the video signal 52 and identifying gestures, which may include manipulation of a laser pointer or other light source. This particular embodiment may be advantageous for use with low-resolution cameras 50, because the laser light reflected off a surface (e.g., projector screen) may be easily identified by the gesture-recognition application 118.

Additionally, the gesture-recognition application 118 may also comprise computer instructions for pre-registering users 40 to use the gesture-recognition application 118 based on, for example, facial recognition. Accordingly, the gesture-recognition application 118 may be configured to recognize only pre-registered users and their gestures and to translate only the registered users' gestures into computer commands. This embodiment may be particularly useful for implementing the gesture-recognition application 118 in a space with multiple persons where it may be desirable to have only one person or a few persons be able to generate computer commands via the gesture-recognition application 118.

The gesture-recognition application 118 may also comprise computer instructions for transmitting the computer commands. In one embodiment, the computer commands may be transmitted to the operating system 116, for example, as keyboard commands (e.g., PgDn, PgUp, etc.) or mouse click commands. In another embodiment, the computer commands may be transmitted to an application 119 via a plug-in for the application 119. Accordingly, user 40 gestures captured by the camera 50 may be translated to computer commands for an operating system 116, application 119 or other component of the computing device 100.

For example, the gesture-recognition application 118 may be useful for providing gesture-based control of a presentation program, such as the Microsoft® PowerPoint® presentation graphics program. Accordingly, in one embodiment, the gesture-recognition application 118 may be configured to generate computer commands for controlling the application 119, which may be, for example, a presentation program such as the Microsoft® PowerPoint® presentation graphics program. In such an embodiment, the presentation data stored in the computing device 10 may be leveraged to facilitate the identification of user gestures. Typically, gesture recognition requires segmenting an image into “foreground” and “background” features, which may include the computationally-intensive task of processing temporal information (e.g. comparing the current video frame to past frames to identify what has moved). The gesture-recognition application 118, however, may be configured to leverage the presentation data stored in the computing device 10 in processing the video signal 52, by processing the visual information corresponding to the presentation being projected by the presentation program as “background.” Further, by leveraging the presentation data stored in the computing device 10, which is projected into the background, a single camera may be employed to implement the gesture-recognition application 118 in 2-D gesture recognition. Thus, the task of extracting “foreground” features may be simplified by providing a less computationally demanding process, which is cheaper to implement in terms of hardware costs (e.g., camera, processors, etc.).

In one embodiment, the computing device 100 illustrated in FIG. 2 may be implemented in a computer system 10 as shown in FIG. 1. The computer system 10 may be, for example, a laptop computer, a personal computer, etc. As shown in FIG. 1, the camera 50 may be connected to the computer system 10. And as shown in FIG. 2, the camera 50 may be connected to the computing device 100 via the input /output controller 112. Therefore, in accordance with instructions defined in the gesture-recognition application 118, the CPU 102 of the computing device 100 may store and process the video signal 52 received from the camera 50, identify predefined gestures performed by the user 40 from the video signal 52, and generate computer commands corresponding to the pre-defined gestures identified from the video signal 52. For example, the gesture-recognition application 118 may be configured to generate computer commands for controlling the application 119 stored in the storage device 114 of the computing device 100. The application 119 may be, for example, a presentation program such as the Microsoft® PowerPoint® presentation graphics program. Accordingly, the computing device 100 may be connected to a video projector 30 for projecting a presentation onto a projection screen 32, which may be controlled by the user 40 by performing pre-defined gestures.

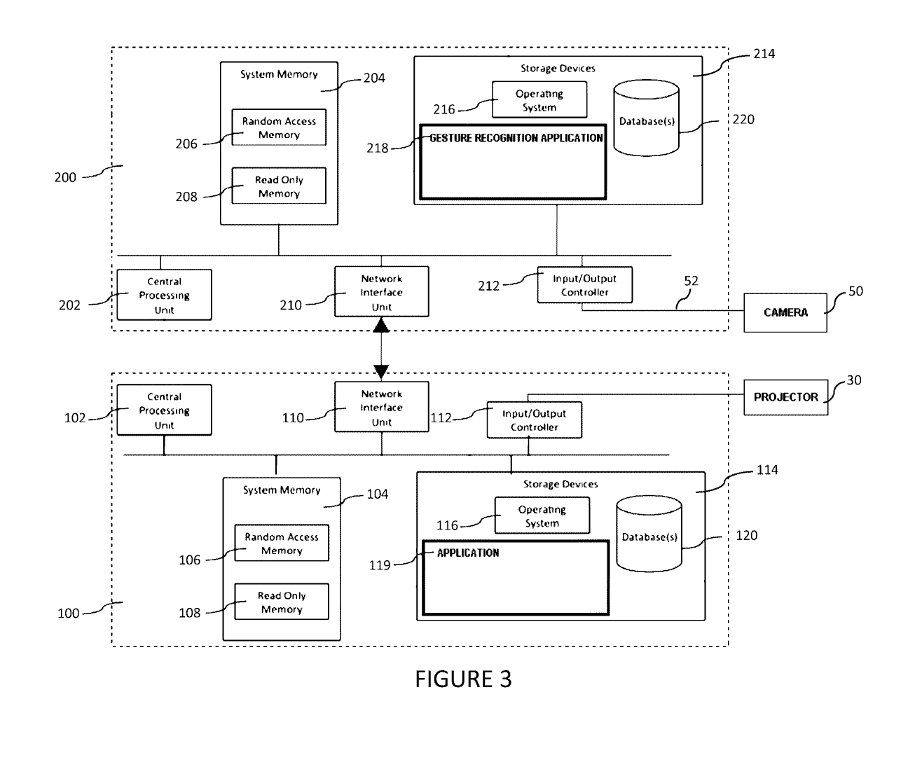

In another embodiment, as illustrated in FIG. 3, the gesture-recognition application 218 may be implemented using two computing devices 100, 200. In FIGS. 2 and 3, like reference numerals refer to like features of the computing devices 100 and 200. Accordingly, the description of computing device 100 with reference to FIG. 2 is equally applicable to each of the computing devices 100 and 200 as shown in FIG. 3. As shown in FIG. 3, the gesture-recognition application 218 may be stored in the storage device 214 and executed by the CPU 202 of the computing device 200 to store and process the video signal 52 received from the camera 50, identify predefined gestures performed by the user 40 from the video signal 52, and generate computer commands corresponding to the pre-defined gestures identified from the video signal 52. Further, as shown, the computing device 200 may be in communication with computing device 100 by means of network interfaces 210, 110. Accordingly, computing device 200 may communicate the computer commands generated by the gesture-recognition application 218 to the computing device 100. In particular, the computer commands generated by the gesture-recognition application 218 in computing device 200 may be transmitted to the operating system 116 or application 119 of the computing device 100. The application 119 may be, for example, a presentation program such as the Microsoft® PowerPoint® presentation graphics program. Accordingly, the computing device 100 may be connected to a video projector 30 for projecting a presentation onto a projection screen 32, which may be controlled by the user 40 by performing pre-defined gestures.

The computing devices 100 and 200 as shown in FIG. 3 may be implemented in a computer system 10 and a mobile computing device 20, respectively, as shown in FIG. 1. The mobile computing device 20 (e.g., smart-phone, tablet computer, etc.) may be configured to execute the gesture-recognition application 218 to process the video signal 52 from, for example, a built-in camera 50; identify pre-defined gestures performed by the user 40; and further generate computer commands corresponding to the pre-defined gestures identified from the video signal and transmit the computer commands to the computer system 10 / computing device 100. The transmission of the computer commands from the mobile computing device 20 to the computer system 10 may be done over any suitable wired (e.g., USB) or wireless (e.g., WiFi™, Bluetooth®, infrared, etc.) communication link.

Alternatively, the computing devices 100 and 200 as shown in FIG. 3 may be implemented in a computer system 10 and a camera 50, respectively, as shown in FIG. 1. The camera 50 may be configured to include a computing device 200 that is adapted to execute the gesture-recognition application 218 to process the video signal 52 from the camera 50; identify pre-defined gestures performed by the user 40; and further generate computer commands corresponding to the pre-defined gestures identified from the video signal and transmit the computer commands to the computer system 10 / computing device 100. The transmission of the computer commands from the camera 50 to the computer system 10 may be done over any suitable wired (e.g., USB) or wireless (e.g., WiFi™, Bluetooth®, infrared, etc.) communication link.

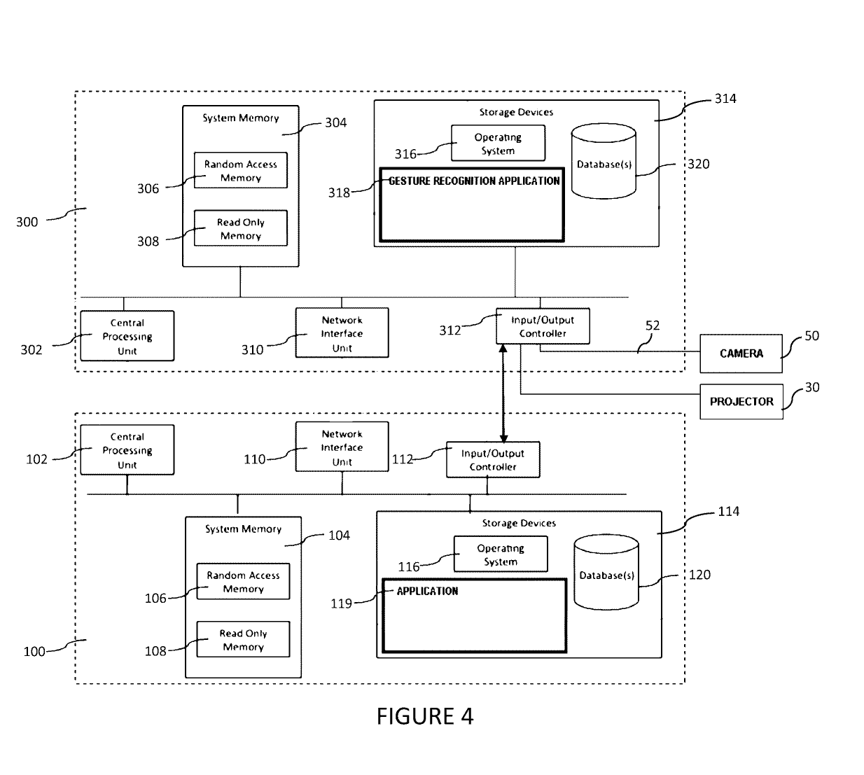

In another embodiment, as illustrated in FIG. 4, the gesture-recognition application 318 may be implemented using two computing devices 100, 300. In FIGS. 2 and 4, like reference numerals refer to like features of the computing devices 100 and 300. Accordingly, the description of computing device 100 with reference to FIG. 2 is equally applicable to each of the computing devices 100 and 300 as shown in FIG. 4. As shown in FIG. 4, the gesture-recognition application 318 may be stored in the storage device 314 and executed by the CPU 302 of the computing device 300 to store and process the video signal 52 received from the camera 50, identify predefined gestures performed by the user 40 from the video signal 52, and generate computer commands corresponding to the pre-defined gestures identified from the video signal 52. Further, as shown, the computing device 300 may be in communication with computing device 100 by means of the input/output controllers 312, 112. Accordingly, computing device 300 may communicate the computer commands generated by the gesture-recognition application 318 to the computing device 100. In particular, the computer commands generated by the gesture-recognition application 318 in computing device 300 may be transmitted to the operating system 116 or application 119 of the computing device 100. The application 119 may be, for example, a presentation program such as the Microsoft® PowerPoint® presentation graphics program.

The computing devices 100 and 300 as shown in FIG. 4 may be implemented in a computer system 10 and a projector 30, respectively, as shown in FIG. 1. The projector 30 may be configured to integrate the computing device 300 shown in FIG. 4 and execute the gesture-recognition application 318 to process the video signal 52 from, for example, a built-in camera 50; identify pre-defined gestures performed by the user 40; and further generate computer commands corresponding to the pre-defined gestures identified from the video signal and transmit the computer commands to the computer system 10/ computing device 100. The transmission of the computer commands from the computing device 300 integrated in the projector 30 to the computer system 10 may be done over any suitable connection (e.g., e.g., HDMI®, DVI, USB, etc.) between the input/output controllers 312, 112.

The term “computer-readable medium” as used herein refers to any medium that provides or participates in providing instructions to the processor 102 of the computing device 100 for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

While various embodiments have been described, it will be appreciated by those of ordinary skill in the art that modifications can be made to the various embodiments without departing from the spirit and scope of the invention as a whole.

What is claimed is:

1. A non-transitory, tangible computer-readable medium storing instructions adapted to be executed by a computer processor to perform a method for gesture-based computer control, comprising the steps of:
receiving, by the computer processor, a video signal;
identifying, by the computer processor, pre-defined gestures in the video signal; and
generating, by the computer processor, computer commands corresponding to the pre-defined gestures in the video signal.

2. The non-transitory, tangible computer-readable medium of claim 1, wherein the method further comprises:
transmitting, by the computer processor, the computer commands to an application executed by the processor.

3. The non-transitory, tangible computer-readable medium of claim 1, wherein the method further comprises:
transmitting, by the computer processor, the computer commands to a remote computer.

4. The non-transitory, tangible computer-readable medium of claim 2, wherein the application is a presentation program and the computer commands are for controlling the presentation program.

5. The non-transitory, tangible computer-readable medium of claim 3, wherein the method further comprises:
identifying, by the computer processor, a pre-registered user by facial recognition; and
identifying, by the computer processor, the pre-defined gestures in the video signal performed by the pre-registered user.

6. The non-transitory, tangible computer-readable medium of claim 1, wherein the video signal is received from only a single camera.

7. A computer-implemented method for gesture-based computer control, comprising the steps of:
receiving, by a computer processor, a video signal;
identifying, by the computer processor, pre-defined gestures in the video signal; and
generating, by the computer processor, computer commands corresponding to the pre-defined gestures in the video signal.

8. The computer-implemented method of claim 7 further comprising:
transmitting, by the computer processor, the computer commands to an application executed by the processor.

9. The computer-implemented method of claim 7 further comprising:
transmitting, by the computer processor, the computer commands to a remote computer.

10. The computer-implemented method of claim 8, wherein the application is a presentation program and the computer commands are for controlling the presentation program.

11. The computer-implemented method of claim 8 further comprising:
identifying, by the computer processor, a pre-registered user by facial recognition; and
identifying, by the computer processor, the pre-defined gestures in the video signal performed by the pre-registered user.

12. The computer-implemented method of claim 7, wherein the video signal is received from only a single camera.

13. A computer system for generating gesture-based computer commands, comprising:
a processor configured to
receive a video signal;
identify pre-defined gestures in the video signal; and
generate computer commands corresponding to the pre-defined gestures in the video signal.

14. The computer system according to claim 13 further comprising a storage device in communication with the processor, the storage device storing a gesture-recognition application comprising instructions to be executed by the processor for identifying pre-defined gestures in the video signal.

15. The computer system according to claim 14, wherein the gesture-recognition application further comprises instructions to be executed by the processor for generating computer commands corresponding to the pre-defined gestures in the video signal.

16. The computer system according to claim 13 further comprising a single camera for generating the video signal.

17. The computer system according to claim 13 further comprising a storage device in communication with the processor, the storage device storing an application.

18. The computer system according to claim 17, wherein the processor is further configured to transmit the computer commands to the application.

19. The computer system according to claim 18, wherein the application is a presentation program.

20. The computer system according to claim 19, wherein the processor is further configured to:
identify a pre-registered user by facial recognition; and
identify the pre-defined gestures in the video signal performed by the pre-registered user.
